(19) United States
(12) Patent Application Publication
(10) Pub. No.: US 2024/0046066 A1
(43) Pub. Date: Feb. 8, 2024

(54) TRAINING A NEURAL NETWORK BY MEANS OF KNOWLEDGE GRAPHS

(71) Applicant: Robert Bosch GmbH, Stuttgart (DE)

(72) Inventors: Lavdim Halilaj, Leonberg (DE); Sebastian Monka, Stuttgart (DE)

(21) Appl. No.: 18/363,512

(22) Filed: Aug. 1, 2023

(30) Foreign Application Priority Data
Aug. 3, 2022 (DE) 10 2022 208 083.1

(51) Int. Cl. G06N 3/04; G06N 3/084

(52) U.S. Cl. CPC G06N 3/04; G06N 3/084

(57) ABSTRACT

A method for training a neural network for evaluating measurement data. The neural network includes a feature extractor for generating feature maps. The method includes: providing training examples labeled with target outputs; providing a generic knowledge graph; selecting a subgraph relating to a context for solving a specified task; ascertaining, for each training example, a feature map using the feature extractor; ascertaining, from the respective training example, a representation of the subgraph in the space of the feature maps; evaluating an output from the feature map; assessing, using a specified cost function, to what extent the feature map is similar to the representation of the subgraph; optimizing parameters that characterize the behavior of the neural network; and adjusting the evaluation of the feature maps such that the output for each training example corresponds as well as possible to the target output for the respective training example.

### CROSS REFERENCE

The present application claims the benefit under 35 U.S.C. § 119 of German Patent Application No. DE 10 2022 208 083.1 filed on Aug. 3, 2022, which is expressly incorporated herein by reference in its entirety.

### FIELD

The present invention relates to training neural networks that can be used, for example, for the classification of images or other measurement data with regard to the presence of particular types of objects.

### BACKGROUND INFORMATION

Neural networks that, for example, classify images or other measurement data with regard to the presence of particular objects are typically monitored for a large amount of training examples labeled with target outputs. After completion of the training, the neural network is expected to also provide the correct output with regard to the specific task posed, for images or measurement data that were not seen during the training.

This is typically ensured at least to the extent that the measurement data input into the neural network during the later operational use belong at least to the same distribution or domain as the training examples. (S. Monka et al., “Learning Visual Models using a Knowledge Graph as a Trainer,” arXiv: 2102.08747v2 (2021)) describes a training method in which at least one feature extractor of the neural network is also trained by means of a representation of generic knowledge from a knowledge graph. As a result, the training generalizes better on measurement data that are no longer completely within the distribution or domain of the training examples.

### SUMMARY

The present invention provides a method for training a neural network for evaluating measurement data. This neural network comprises a feature extractor for generating feature maps from the measurement data. Measurement data input into the neural network thus first pass through the feature extractor and are processed to form a feature map before an output with regard to a specified task is ascertained from this feature map in the next step.

For example, the feature extractor may comprise a stack of convolutional layers. In each of these convolutional layers, at least one feature map whose dimensionality is reduced in comparison to the input of the convolutional layer is generated from the input of the convolutional layer by applying one or more filter cores in a defined raster.

According to an example embodiment of the present invention, within the scope of the method, training examples that are labeled with target outputs with respect to a specified task are provided. Furthermore, a generic knowledge graph is provided whose nodes represent entities and whose edges represent relationships between these entities. In a directed knowledge graph, it is, for example, possible to encode in this way that an object, represented by a node, or another entity
has a particular property, by creating a further node with the specific property and by the original node referencing the further node with an edge “has property;”
has a subclass, by creating a further node with the specific subclass and by the further node referencing the original node with an edge “is subclass of;” and/or
belongs to a superordinate class, by creating a further node with the specific superordinate class and by the original node referencing the further node with an edge “is subclass of.”

For example, a traffic sign may have a shape, a color, and a symbol and may be valid in a particular country. For example, the class “traffic signs” may include subclasses for indication signs, danger signs, mandatory signs, prohibition signs, and yield signs. Conversely, the class “traffic signs” may be a subclass of “traffic-related objects.”

A subgraph that relates to a context for the solution of the specified task is selected from the generic knowledge graph. In this case, the context may be specified. However, as is explained below, the selection of the subgraph may also take place automatically, in whole or in part, as part of an optimization.

For each training example, a feature map is now ascertained by means of the feature extractor of the neural network. Furthermore, a representation of the subgraph in the space of the feature maps is ascertained from the respective training example in connection with the respective target output. In this respect, “in the space of the feature maps” in particular means that a comparison and/or a similarity measure or distance measure between a representation on the one hand and a feature map on the other hand is declared.

For example, the representation may, in particular, be ascertained by any “knowledge graph embedding” method that converts the subgraph into a representation that allows differences between entities in the form of distances to be recognized. For example, a graph neural network (GNN) that receives the subgraph as input can be used for this purpose. Such a GNN may, in particular, ascertain a representation for each node of the subgraph, for example.

An output from the feature map is evaluated with regard to the specified task. This may, for example, take place with a task head that can also be trained. However, as explained below, especially for the task of classifying, this task head may also be replaced by modeling the evaluation as a Gaussian process.

It is now assessed, by means of a specified cost function, to what extent the feature map is similar to the representation of the subgraph.

Parameters that characterize the behavior of the neural network are optimized with the goal that the assessment by the cost function is expected to improve during the further processing of training examples. For example, the parameters may in particular include weights by means of which inputs supplied to a neuron or another processing unit of the neural network are summed weighted. Furthermore, the evaluation of the feature maps is adjusted such that the output for each training example corresponds as well as possible to the target output for the respective training example.

For example, the changes to the parameters for the respectively next learning step may, in particular, be ascertained in a gradient descent method in which the neural network backpropagates the assessment by the cost function and converts it into gradients along which the respective parameters are to be changed in the next learning step.

It has been found that frequently, only a small portion of the entire knowledge stored in the knowledge graph is relevant to the solution of a specific task. The effect of this small portion can be covered or neutralized, in whole or in part, by a lot of further knowledge that is not relevant to the specific task. This tendency is suppressed by the preselection of the subgraph.

Furthermore, by focusing on a particular context, the selection of the subgraph suppresses the occurrence of ambiguities. These ambiguities can be illustrated on the basis of the human perception of so-called “tilted images.” “Tilted images” are subjectively perceived with one of several possible semantic meanings depending on the context a person associates with them. For example, someone who looks at the image of the Rubin's vase and thinks of objects will also recognize a vase in the image. On the other hand, someone who associates the image with people will recognize two faces facing one another in the image. If a very extensive knowledge graph is now converted into a representation in the space of the feature maps, several possible semantic meanings, i.e., for example, “vase” and “face,” can be superimposed therein, which could worsen or even cancel out the effect aimed to be achieved with the use of the knowledge graph. By selecting a context as proposed herein, exactly one semantic meaning is selected in such cases.

In a particularly advantageous embodiment, the neural network additionally comprises a task head for evaluating these feature maps with regard to the specified task. This task head can also be trained. Adjusting the evaluation of the feature maps then includes
assessing, by means of a cost function, how well the output of the task head for each training example corresponds to the target output for the respective training example, and
optimizing the parameters of the task head with regard to the assessment by the cost function as well.

For example, a cost function with two contributions may be used. A first contribution relates to the similarity between the feature map and the representation of the subgraph, and a second contribution relates to the match between the output and the target output. When optimizing the parameters, for example via gradient descent, the first contribution will then only affect the parameters of the feature extractor since this similarity does not depend on the behavior of the task head. On the other hand, the second contribution may well affect both parameters of the task head and parameters of the feature extractor since the feature map is the basis for the work of the task head.

However, the task head may, for example, also be separately trained by means of its own cost function after the optimization with regard to the similarity between the feature map and the representation of the subgraph, while the parameters characterizing the behavior of the feature extractor are frozen.

For example, the task head may in particular include a fully meshed layer that has access to the entire, most recently calculated feature map and compresses this feature map to form the desired output.

In a particularly advantageous example embodiment of the present invention, the similarity between the feature map and the representation of the subgraph is set in relation to the similarity between the representation of the subgraph and feature maps ascertained for other training examples with other target outputs. The assessment by the cost function is thus the better,
the more similar the feature map ascertained from the respective training example is to the representation of the subgraph ascertained on the basis of this training example (“positive examples”), and
the more dissimilar the representation of the subgraph is to the feature maps ascertained for other training examples with other target outputs (“negative examples”).

The contribution to the cost function (also referred to as a loss function) that relates to the similarity to the representation of the subgraph thus becomes a “contrastive loss,” which is comparable in the broadest sense to a signal-to-noise ratio in telecommunications. The similarities or dissimilarities can be measured with any suitable similarity measure, e.g., with the cosine similarity.

For example, the target outputs may in particular include classification scores with respect to one or more classes of a specified classification of the measurement data. The neural network may thus be configured as a classifier for the measurement data. For example, classes may in particular represent types of objects whose presence in an area monitored during the recording of the measurement data is indicated by the measurement data. Especially in such applications, the dissolution of ambiguities is particularly advantageous.

For example, vehicles, traffic signs, roadway markings, traffic obstructions and/or other traffic-relevant objects in the vicinity of a vehicle may in particular be selected as types of objects. Especially with these types of objects, the generalization intended by the use of the knowledge graph on a distribution or domain that deviates from the distribution or domain of the training examples is particularly important. For example, traffic signs with the same semantic meaning look a little different in other countries. For example, in most countries in Europe, danger signs consist of a red triangle enclosing a white surface on which a symbol is located. Different countries use different shades of red for the triangle or draw the symbol slightly differently. In addition, Finland and Greece use a yellow surface instead of a white surface within the red triangle.

At the same time, with traffic signs and other traffic-relevant objects, the unambiguity of the recognition is important, which is improved by focusing on a particular context.

In a further, advantageous example embodiment of the present invention, evaluating the feature maps includes assigning the feature maps to classes by means of a Gaussian process. Adjusting this evaluation then includes
ascertaining feature maps for all training examples, and
defining decision limits between classes in the space of the feature maps on the basis of the respective target outputs.

In particular, respective average and covariance matrices may be ascertained for each individual class from the entirety of all the feature maps. The decision limits between classes can then be defined therefrom.

When measurement data are supplied to the trained neural network during the later operational use, these measurement data are first processed with the feature extractor to form a feature map. For each class, the Gaussian process then assigns a probability of the feature map belonging to this class, to this feature map. The class with the maximum probability can then be rated as the final decision of the classifier.

The use of a Gaussian process instead of a task head for the assignment of the feature map to a class has the advantage that interactions between the training of the feature extractor on the one hand and the training of the task head on the other hand are avoided. Such interactions could interfere with the training of the feature extractor by means of the subgraph since the training of the task head cannot benefit from the use of the subgraph.

For example, images, audio signals, time series of measured values, radar data and/or lidar data may in particular be selected as measurement data. Especially these types of data are very multi-faceted in the sense that they can contain information with respect to many aspects. By selecting the subgraph, the aspect to be investigated can be selected. For example, the subgraph may in particular relate to a visual, taxonomic or functional context of the measurement data.

The visual context describes abstract visual properties of objects, such as color, shape or texture. These properties may or may not be present in a specified set of training examples. By using the subgraph, the training examples can be advantageously expanded in this respect. For example, if the data set of training examples only contains images in which any horses present are white, the additional information that horses can also have other colors can be conveyed to the feature extractor via the subgraph.

The taxonomic context describes relationships between classes on the basis of hierarchies. By means of a taxonomy, external prior knowledge may in particular be taken into consideration, for example. For example, there is a taxonomy of the traffic signs to the extent that the traffic sign can indicate information, a warning, a rule, a mandatory action or a prohibition. This taxonomy thus includes an important portion of the semantic meaning of the traffic sign, which meaning is required for automated driving, for example.

The functional context contains properties that describe the function of an object. For example, tools may be categorized according to whether they are used to screw, saw, or drill.

In a further, particularly advantageous example embodiment of the present invention, the selection of the subgraph is also included in the optimization with respect to the assessment by the cost function. It is thus possible, for example, to ascertain the subgraph for which the best match between the representation of this subgraph and feature maps generated from training examples can be achieved. For example, a plurality of candidate subgraphs maybe compiled, and the training of the neural network may be performed for each of these candidate subgraphs. For example, the candidate subgraph for which the best value of the cost function can be achieved may then finally be selected. For example, compiling the candidate subgraphs may in particular include searching a search space of subgraphs systematically and/or ascertaining candidate subgraphs on the basis of a heuristic. By taking into consideration prior knowledge about the content of the knowledge graph, the search space can in particular be narrowed down and/or this prior knowledge can be included in the heuristic.

In a further, advantageous embodiment of the present invention, the representation of the subgraph in the space of the feature maps is retrieved from a pre-calculated lookup table on the basis of the training example and the target output. The effort for calculating the representation of the subgraph can thus be moved upstream.

In a further, advantageous example embodiment of the present invention, a further machine learning model for generating the representation of the subgraph in the space of the feature maps is trained together with the neural network. For this purpose, a graph neural network (GNN) may, for example, be used, which receives the subgraph, or even the generic knowledge graph, as an input. The feature extractor on the one hand and the generation of the representation of the subgraph on the other hand can then equally contribute to maximizing the similarity between the feature map and the representation of the subgraph.

In a further, advantageous embodiment of the present invention, measurement data are supplied to the trained neural network. A control signal is formed from the outputs of the neural network. This control signal is used to control a vehicle, a driver assistance system, a quality control system, an area monitoring system, and/or a medical imaging system. Due to the improved ability of the neural network to generalize beyond the training examples used during the training, the probability of the response of the respectively controlled system being appropriate to the situation captured with the measurement data is then increased.

The method may in particular be computer-implemented as a whole or in part. The present invention therefore also relates to a computer program including machine-readable instructions which, when executed on one or more computers and/or compute instances, cause the computer(s) and/or compute instance(s) to perform the method described. In this sense, control devices for vehicles and embedded systems for technical devices that are likewise capable of executing machine-readable instructions are also to be regarded as computers. Examples of compute instances include virtual machines, containers, or serverless execution environments for executing machine-readable instructions in a cloud.

Likewise, the present invention also relates to a machine-readable data storage medium and/or to a download product including the computer program. A download product is a digital product that can be transmitted via a data network, i.e., can be downloaded by a user of the data network, and may, for example, be offered for sale in an online shop for immediate download.

Furthermore, according to an example embodiment of the present invention, a computer may be equipped with the computer program, with the machine-readable storage medium or with the download product.

Further measures improving the present invention are described in more detail below on the basis of the figures, together with the description of the preferred exemplary embodiments of the present invention.

### BRIEF DESCRIPTION OF THE DRAWINGS

FIG. 1 shows an exemplary embodiment of the method 100 for training a neural network 1, according to the present invention.

FIG. 2 shows an illustration of the consideration of various contexts via subgraphs 43 of a generic knowledge graph 4.

### DETAILED DESCRIPTION OF EXAMPLE EMBODIMENTS

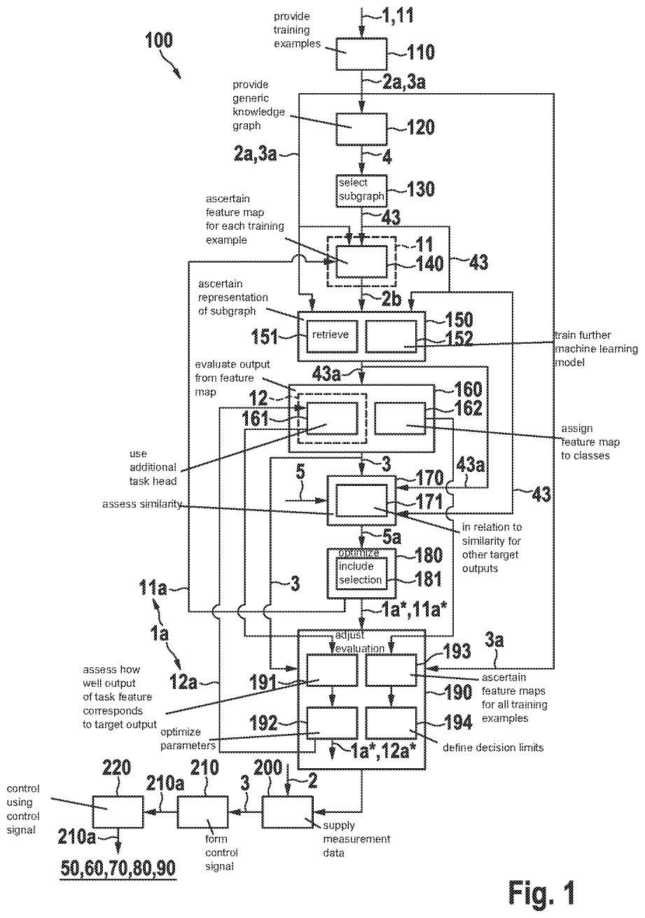

FIG. 1 is a schematic flow chart of an exemplary embodiment of the method for training a neural network 1. This neural network 1 comprises a feature extractor 11 for generating feature maps 2a from the measurement data 2.

In step 110, training examples 2a are provided. These training examples 2a are labeled with target outputs 3a with respect to a specified task.

In step 120, a generic knowledge graph 4 is provided whose nodes 41 represent entities and whose edges 42 represent relationships between these entities. For example, an object as a first entity 41 may be associated with a property as a second entity 41 via a relationship “has/is” as an edge 42.

In step 130, a subgraph 43 relating to a context for solving the specified task is selected from the generic knowledge graph 4.

In step 140, a feature map 2b for each training example 2a is ascertained by means of the feature extractor 11 of the neural network.

In step 150, a representation 43a of the subgraph 43 in the space of the feature maps 2b is ascertained from the respective training example 2a in connection with the respective target output 3a.

According to block 151, the representation 43a of the subgraph 43 in the space of the feature maps 2b can be retrieved from a pre-calculated lookup table on the basis of the training example 2a and the target output 3a.

According to block 152, a further machine learning model for generating the representation 43a of the subgraph 43 in the space of the feature maps 2b can be trained together with the neural network 1.

In step 160, an output 3 from the feature map 2b is evaluated with regard to the specified task.

According to block 161, the output 3 from the feature map 2b can be evaluated by means of an additional task head 12 of the neural network 1.

According to block 162, evaluating the feature maps 2b can include assigning the feature maps 2b to classes as output 3 by means of a Gaussian process.

In step 170, a specified cost function 5 is used to assess to what extent the feature map 2b is similar to the representation 43a of the subgraph 43. The cost function 5 outputs an assessment 5a.

According to block 171, the similarity between the feature map 2b and the representation 43a of the subgraph 43 can be set in relation to the similarity between the representation 43a of the subgraph 43 and feature maps 2b′ ascertained for other training examples 2a′ with other target outputs 3a′.

In step 180, parameters 1a, 11a that characterize the behavior of the neural network 1 (and in this case, in particular, of the feature extractor 11) are optimized with the goal that the assessment 5a by the cost function 5 is expected to improve during the further processing of training examples 2a. The fully trained state of the parameters 1a, 11a is denoted by reference sign 1a*, 11a*.

According to block 181, the selection of the subgraph 43 can also be included in the optimization with respect to assessment 5a by the cost function 5.

In step 190, the evaluation of the feature maps 2b is adjusted such that the output 3 for each training example 2a corresponds as well as possible to the target output 3a for the respective training example 2a.

If the feature maps 2b are evaluated according to block 161 by means of a task head 12, a cost function 5, 5′ can be used according to block 191 to assess how well the output 3 of the task head 12 for the respective training example corresponds to the target output 3a for the respective training example 2a. Then, according to block 192, the parameters 1a, 12a of the task head 12 can be optimized with regard to the assessment 5a, 5a′ by the cost function 5, 5′. This training can be performed simultaneously with the training of the feature extractor 11 or only after completion of the training of the feature extractor 11.

If the feature maps 2b are evaluated according to block 162 by means of a Gaussian process, feature maps 2b for all training examples 2a can be ascertained according to block 193. According to block 194, decision limits between classes in the space of the feature maps 2b can then be defined on the basis of the respective target outputs 3a.

In the example shown in FIG. 1, in step 200, measurement data 2 are supplied to the trained neural network 1 so that the trained neural network 1 generates outputs 3.

In step 210, a control signal 210a is formed from the outputs 3 of the neural network 1.

In step 220, a vehicle 50, a driver assistance system 60, a quality control system 70, an area monitoring system 80, and/or a medical imaging system 90 are controlled by means of the control signal 210a.

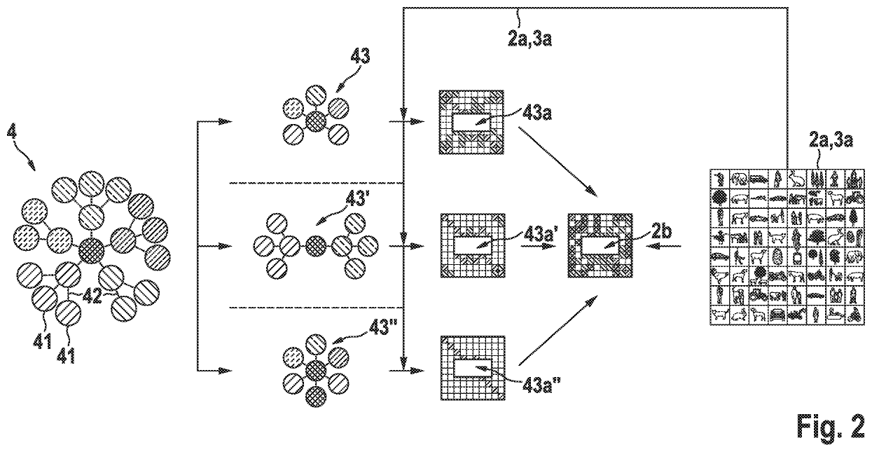

FIG. 2 illustrates how various contexts via subgraphs 43 of a generic knowledge graph 4 can be taken into consideration for the training of the neural network 1.

The first subgraph 43 represents a visual context and has an exemplary representation 43a in the space of the feature maps 2b. The second subgraph 43′ represents a taxonomic context and has an exemplary representation 43a′ in the space of the feature maps 2b. The third subgraph 43″ represents a taxonomic context and has an exemplary representation 43a″ in the space of the feature maps 2b.

Depending on which context is selected, for a given training example 2a with target output 3a, the representation 43a, 43a′ or 43a″ of the respective subgraph 43, 43′ or 43″ is compared to the feature map 2b of the training example 2a and the similarity is assessed.

What is claimed is:

1. A method for training a neural network for evaluating measurement data, wherein the neural network includes a feature extractor configured to generate feature maps from the measurement data, the method comprising the following steps:
providing training examples labeled with respective target outputs with respect to a specified task;
providing a generic knowledge graph whose nodes represent entities and whose edges represent relationships between the entities;
selecting, from the generic knowledge graph, a subgraph relating to a context for solving the specified task;
ascertaining, for each training example, a respective feature map using the feature extractor of the neural network;
ascertaining, from each respective training example in connection with the respective target output, a representation of the subgraph in a space of the respective feature maps;
evaluating an output from each respective feature map with regard to the specified task;
assessing, using a specified cost function, to what extent the respective feature maps are similar to the representation of the subgraph;
optimizing parameters that characterize the behavior of the neural network, with a goal that the assessment by the cost function is expected to improve during further processing of training examples; and
adjusting the evaluation of the feature maps such that the output for each training example corresponds as well as possible to the respective target output for the respective training example.

2. The method according to claim 1, wherein the neural network additionally includes a task head configured to evaluate the respective feature maps with regard to the specified task, and wherein the adjustment of the evaluation of the feature maps includes:
assessing, using a cost function, how well the output of the task head for each training example corresponds to the target output for the respective training example; and
optimizing parameters of the task head with regard to the assessment by the cost function.

3. The method according to claim 1, wherein the similarity between each respective feature map and the representation of the subgraph is set in relation to the similarity between the representation of the subgraph and feature maps ascertained for other training examples with other respective target outputs.

4. The method according to claim 1, wherein the respective target outputs include classification scores with respect to one or more classes of a specified classification of the measurement data.

5. The method according to claim 4, wherein classes of the specified classification represent types of objects whose presence in an area monitored during recording of the measurement data is indicated by the measurement data.

6. The method according to claim 5, wherein other vehicles, and/or traffic signs, and/or roadway markings, and/or traffic obstructions and/or other traffic-relevant objects in the vicinity of a vehicle are selected as types of objects.

7. The method according to claim 4, wherein the evaluating of the respective feature maps includes assigning the respective feature maps to classes using a Gaussian process, and the adjustment of the evaluation includes:
ascertaining respective feature maps for all training examples; and
defining decision limits between classes in the space of the respective feature maps based on the respective target outputs.

8. The method according to claim 1, wherein images, audio signals, and/or time series of measured values, and/or radar data, and/or lidar data are selected as measurement data.

9. The method according to claim 1, wherein the subgraph relates to a visual or taxonomic or functional context.

10. The method according to claim 1, wherein the selection of the subgraph is also included in the optimization with respect to the assessment by the cost function.

11. The method according to claim 1, wherein the representation of the subgraph in the space of the respective feature maps is retrieved from a pre-calculated lookup table based on each training example and the respective target output.

12. The method according to claim 1, wherein a further machine learning model configured to generate the representation of the subgraph in the space of the feature maps is trained together with the neural network.

13. The method according to claim 1, wherein:
measurement data are supplied to the trained neural network so that the trained neural network generates outputs;
a control signal is formed from outputs of the neural network; and
a vehicle and/or a driver assistance system and/or a quality control system and/or an area monitoring system and/or a medical imaging system, is controlled using the control signal.

14. A non-transitory machine-readable storage medium on which is stored a computer program including machine-readable instructions for training a neural network for evaluating measurement data, wherein the neural network includes a feature extractor configured to generate feature maps from the measurement data, the instructions, when executed by one or more computers and/or compute instances, cause the one or more computers and/or compute instances to perform the following steps:
providing training examples labeled with respective target outputs with respect to a specified task;
providing a generic knowledge graph whose nodes represent entities and whose edges represent relationships between the entities;
selecting, from the generic knowledge graph, a subgraph relating to a context for solving the specified task;
ascertaining, for each training example, a respective feature map using the feature extractor of the neural network;
ascertaining, from each respective training example in connection with the respective target output, a representation of the subgraph in a space of the respective feature maps;
evaluating an output from each respective feature map with regard to the specified task;
assessing, using a specified cost function, to what extent the respective feature maps are similar to the representation of the subgraph;
optimizing parameters that characterize the behavior of the neural network, with a goal that the assessment by the cost function is expected to improve during further processing of training examples; and
adjusting the evaluation of the feature maps such that the output for each training example corresponds as well as possible to the respective target output for the respective training example.

15. One or more computers and/or compute instances for training a neural network for evaluating measurement data, wherein the neural network includes a feature extractor configured to generate feature maps from the measurement data, the one or more computers and/or compute instances configured to:
provide training examples labeled with respective target outputs with respect to a specified task;
provide a generic knowledge graph whose nodes represent entities and whose edges represent relationships between the entities;
select, from the generic knowledge graph, a subgraph relating to a context for solving the specified task;
ascertain, for each training example, a respective feature map using the feature extractor of the neural network;
ascertain, from each respective training example in connection with the respective target output, a representation of the subgraph in a space of the respective feature maps;
evaluate an output from each respective feature map with regard to the specified task;
assess, using a specified cost function, to what extent the respective feature maps are similar to the representation of the subgraph;
optimize parameters that characterize the behavior of the neural network, with a goal that the assessment by the cost function is expected to improve during further processing of training examples; and
adjust the evaluation of the feature maps such that the output for each training example corresponds as well as possible to the respective target output for the respective training example.
